(19) United States
(12) Patent Application Publication
(10) Pub. No.: US 2017/0060934 A1
(43) Pub. Date: Mar. 2, 2017

(54) MODIFYING A COMPRESSED BLOCK OF DATA

(71) Applicant: Pure Storage, Inc., MOUNTAIN VIEW, CA (US)

(72) Inventor: CONSTANTINE SAPUNTZAKIS, MOUNTAIN VIEW, CA (US)

(21) Appl. No.: 14/842,947

(22) Filed: Sep. 2, 2015

(51) Int. Cl. G06F 17/30

(52) U.S. Cl. CPC G06F 17/30371; G06F 17/30342

(57) ABSTRACT

Modifying a compressed block of data, including: splitting the compressed block of data into a leading compressed portion and a trailing compressed portion, wherein neither the leading compressed portion nor the trailing compressed portion includes an outdated portion of the compressed block of data; creating an updated compressed block to replace the outdated portion; and combining the leading compressed portion, the updated compressed block, and the trailing compressed portion.

### BACKGROUND OF THE INVENTION

Field of the Invention

The field of the invention is modifying a compressed block of data.

Description of Related Art

Modern computing systems frequently store data that has been compressed to reduce the amount of memory required to store such data. Modifying compressed data, however, can be resource intensive as the data may need to be decompressed, modified, and then recompressed. Performing decompression and compression operations not only consumes computing resources such as processor cycles, but may also increase the amount of time required to modify stored data.

### SUMMARY OF THE INVENTION

Methods, apparatuses, and products for modifying a compressed block of data, including: splitting the compressed block of data into a leading compressed portion and a trailing compressed portion, wherein neither the leading compressed portion nor the trailing compressed portion includes an outdated portion of the compressed block of data; creating an updated compressed block to replace the outdated portion; and combining the leading compressed portion, the updated compressed block, and the trailing compressed portion.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of a computing system according to embodiments of the present disclosure.

FIG. 2 sets forth a flowchart illustrating an example method of modifying a compressed block of data according to embodiments of the present disclosure.

FIG. 3 sets forth a flowchart illustrating an additional example method of modifying a compressed block of data according to embodiments of the present disclosure.

FIG. 4 sets forth a flowchart illustrating an additional example method of modifying a compressed block of data according to embodiments of the present disclosure.

FIG. 5 sets forth a flowchart illustrating an additional example method of modifying a compressed block of data according to embodiments of the present disclosure.

FIG. 6 sets forth a flowchart illustrating an additional example method of modifying a compressed block of data according to embodiments of the present disclosure.

### DETAILED DESCRIPTION OF EXAMPLE EMBODIMENTS

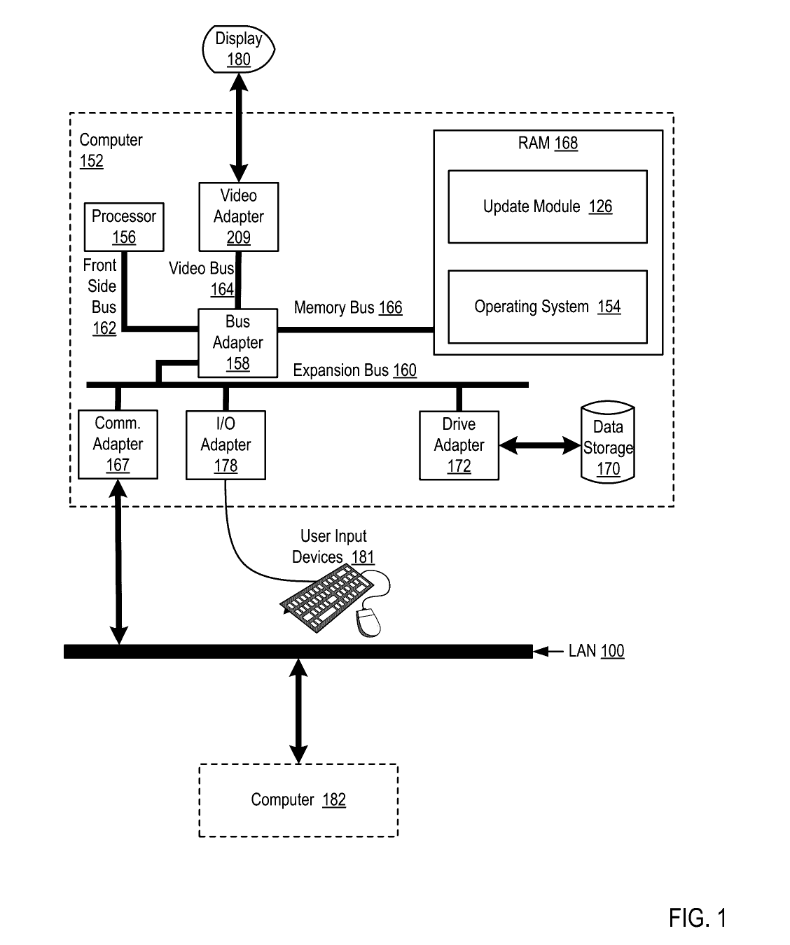

Example methods, apparatuses, and products related to modifying a compressed block of data in accordance with the present disclosure are described with reference to the accompanying drawings, beginning with FIG. 1. FIG. 1 sets forth a block diagram of automated computing machinery comprising an example computing system, depicted here as computer (152), useful in modifying a compressed block of data according to embodiments of the present disclosure. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is an update module (126), a module of computer program instructions for modifying a compressed block of data according to embodiments of the present disclosure. The update module (126) may be configured to modify a compressed block of data by: splitting the compressed block of data into a leading compressed portion and a trailing compressed portion, wherein neither the leading compressed portion nor the trailing compressed portion includes an outdated portion of the compressed block of data; creating an updated compressed block to replace the outdated portion; and combining the leading compressed portion, the updated compressed block, and the trailing compressed portion, as will be described in greater detail below.

Also stored in RAM (168) is an operating system (154). Operating systems useful for modifying a compressed block of data according to embodiments of the present disclosure include UNIX™, Linux™, Microsoft XP™, AIX™, and others as will occur to those of skill in the art. The operating system (154) and the update module (126) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for modifying a compressed block of data according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 also includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 also includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for modifying a compressed block of data according to embodiments of the present disclosure include modems for wired dial-up communications, Ethernet (IEEE 802.3) adapters for wired data communications network communications, and 802.11 adapters for wireless data communications network communications.

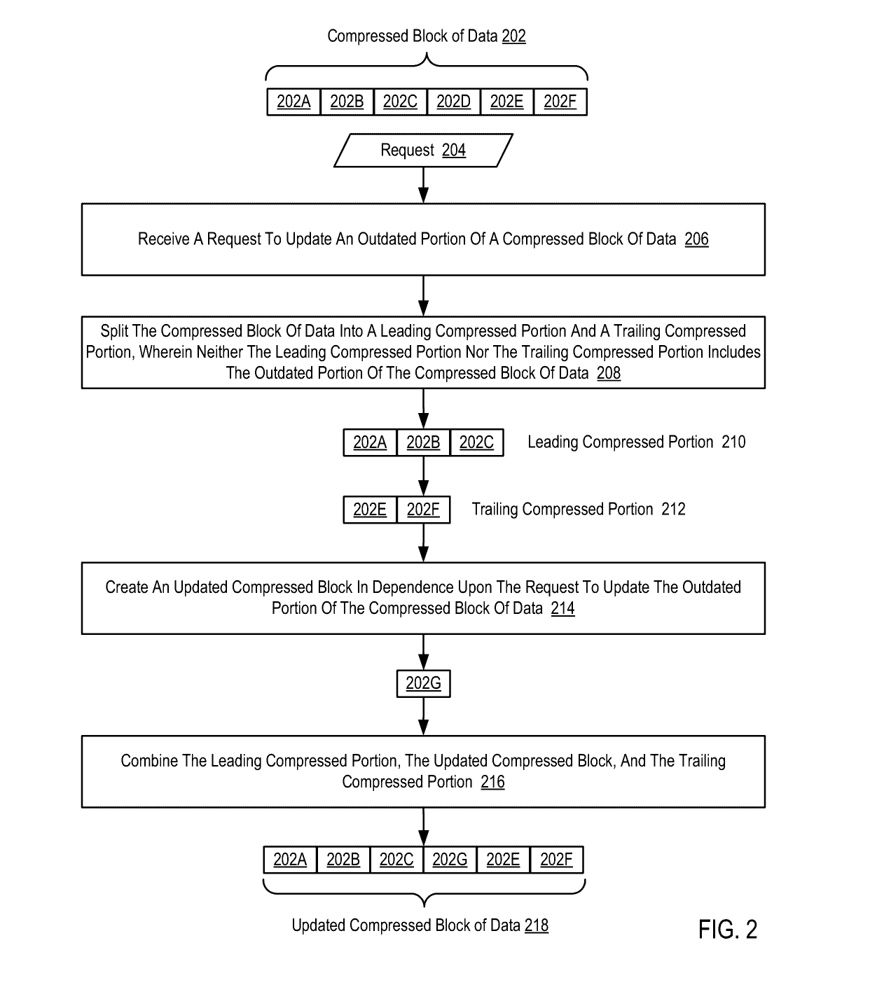

For further explanation, FIG. 2 sets forth a flowchart illustrating an example method of modifying a compressed block of data according to embodiments of the present disclosure. The compressed block of data (202) depicted in FIG. 2 represents a unit of data that has been compressed using a data compression algorithm such as, for example, a Lempel-Ziv-Oberhumer (‘LZO’) data compression algorithm, a run-length encoding (‘RLE’) data compression algorithm, and so on. The unit of data may be embodied, for example, as logical unit such as a file, as a memory unit such as a page or a block, as a predetermined size of data, as a unit of data that can compress down to a predetermined size, or as any other unit of data.

In the example method depicted in FIG. 2, the compressed block of data (202) is illustrated as containing a plurality of sub-portions (202A, 202B, 202C, 202D, 202E, 202F). Such sub-portions (202A, 202B, 202C, 202D, 202E, 202F) may be fixed blocks of a predetermined size, variable sized blocks of a predetermined size, fix sized blocks whose size is set based on some user input, variable sized blocks whose size is set based on some user input, and so on. Readers will appreciate that the presence and number of sub-portions (202A, 202B, 202C, 202D, 202E, 202F) illustrated in FIG. 2 is only for illustrative purposes and is not a requirement of a compressed block of data (202) according to embodiments of the present disclosure.

The example method depicted in FIG. 2 includes receiving (206) a request (204) to update an outdated portion of a compressed block of data (202). In the example method depicted in FIG. 2, the request (204) to update an outdated portion of a compressed block of data (202) may be embodied, for example, as a request to write data to a logical address that corresponds to the compressed block of data (202). Consider an example in which the compressed block of data (202) is a compressed version of a particular file. In such an example, the request (204) to update the outdated portion of the compressed block of data (202) may be embodied as a request to modify the file. In an alternative example in which the compressed block of data (202) is a compressed version of all data contained in a particular logical address range of a storage device, the request (204) to update the outdated portion of the compressed block of data (202) may be embodied as any request to write data to some portion of the particular logical address range.

The example method depicted in FIG. 2 also includes splitting (208) the compressed block of data (202) into a leading compressed portion (210) and a trailing compressed portion (212). Splitting (208) the compressed block of data (202) into the leading compressed portion (210) and the trailing compressed portion (212) may be carried out, for example, through the use of one or more truncate functions. In such an example, a truncate function may be used to truncate the portion of the compressed block of data (202) that precedes the outdated portion of the compressed block of data (202).

Consider the example depicted in FIG. 2 where the compressed block of data (202) includes six sub-portions (202A, 202B, 202C, 202D, 202E, 202F). For example, if the compressed block of data (202) represents six logical pages of compressed data in a storage device, each sub-portion (202A, 202B, 202C, 202D, 202E, 202F) of the compressed block of data (202) may represent one logical page in a storage device. In such an example, if the request (204) to update an outdated portion of the compressed block of data (202) is embodied as a request to perform a write operation on the fourth logical page in the storage device (e.g., the logical page represented by sub-portion (202D) of the compressed block of data (202)), splitting (208) the compressed block of data (202) into a leading compressed portion (210) may be carried out by performing a truncate operation on the compressed block of data (202) that truncates the last three sub-portions (202D, 202E, 202F) of the compressed block of data (202), thereby producing the leading compressed portion (210) of the compressed block of data (202).

In the same example, splitting (208) the compressed block of data (202) into a leading compressed portion (210) and a trailing compressed portion (212) may be further carried out by performing an ‘offset truncation’ operation on the compressed block of data (202). An ‘offset truncation’ operation may be embodied, for example, as a truncate operation that receives an offset value as an input, where the offset value is used to determine where the truncation begins. For example, an ‘offset truncation’ operation that is passed a value of 512 bytes an offset value, may begin its truncation of a block of data 512 bytes from the beginning of the block of data. Continuing with the example described above, if the request (204) to update an outdated portion of the compressed block of data (202) is embodied as a request to perform a write operation on the fourth logical page in the storage device (e.g., the logical page represented by sub-portion (202D) of the compressed block of data (202)), splitting (208) the compressed block of data (202) into a trailing compressed portion (212) may be carried out by performing an ‘offset truncation’ operation on the compressed block of data (202) where the offset value is equal to the first four sub-portions (202A, 202B, 202C, 202D) of the compressed block of data (202) and anything that precedes the last two sub-portions (202E, 202F) is truncated, thereby producing the trailing compressed portion (212) of the compressed block of data (202).

Readers will appreciate that in the example method depicted in FIG. 2, neither the leading compressed portion (210) nor the trailing compressed portion (212) includes the outdated portion of the compressed block of data (202). In the example method depicted in FIG. 2, performing the operations described above would generate a leading compressed portion (210) that includes three sub-portions (202A, 202B, 202C) that do not include the outdated portion of the compressed block of data (202), which in the example described above is sub-portion (202D). Likewise, performing the operations described above would generate a trailing compressed portion (212) that includes two sub-portions (202E, 202F) that do not include the outdated portion of the compressed block of data (202), which in the example described above is sub-portion (202D). Readers will appreciate that both the leading compressed portion (210) and the trailing compressed portion (212) are compressed blocks of data that have not been decompressed since the original compressed block of data (202) was formed.

The example method depicted in FIG. 2 also includes creating (214) an updated compressed block (202G) in dependence upon the request (204) to update the outdated portion of the compressed block of data (202). Creating (214) an updated compressed block in dependence upon the request (204) to update the outdated portion of the compressed block of data (202) may be carried out, for example, by retrieving data that is to replace the outdated portion of the compressed block of data (202) and compressing such data using the same compression algorithm that was originally used to compress the compressed block of data (202).

Consider an example in which the compressed block of data (202) includes a compressed version of all data stored in a range of addresses. Assume that in such an example the request (204) to update an outdated portion of the compressed block of data (202) is embodied a request to modify one of the pages in the range of addresses. In such an example, the request (204) may include data that is to be written to the page that is to be modified. Creating (214) the updated compressed block may therefore be carried out by compressing the data that is to be written to the page that is to be modified using the same compression algorithm that was originally used to compress the compressed block of data (202).

The example method depicted in FIG. 2 also includes combining (216) the leading compressed portion (210), the updated compressed block (202G), and the trailing compressed portion (212). In the example method depicted in FIG. 2, combining (216) the leading compressed portion (210), the updated compressed block (202G), and the trailing compressed portion (212) may be carried out through the use of techniques and functions for concatenating two or more compressed blocks of data. More specifically, the leading compressed portion (210) and the updated compressed block (202G) may be concatenated together, while the updated compressed block (202G) and the trailing compressed portion (212) are also concatenated together. Readers will appreciate that other functions such as, for example, a merge multiple compressed blocks function that combines two or more compressed blocks of data into a single compressed block of data may be utilized to combine (216) the leading compressed portion (210), the updated compressed block (202G), and the trailing compressed portion (212).

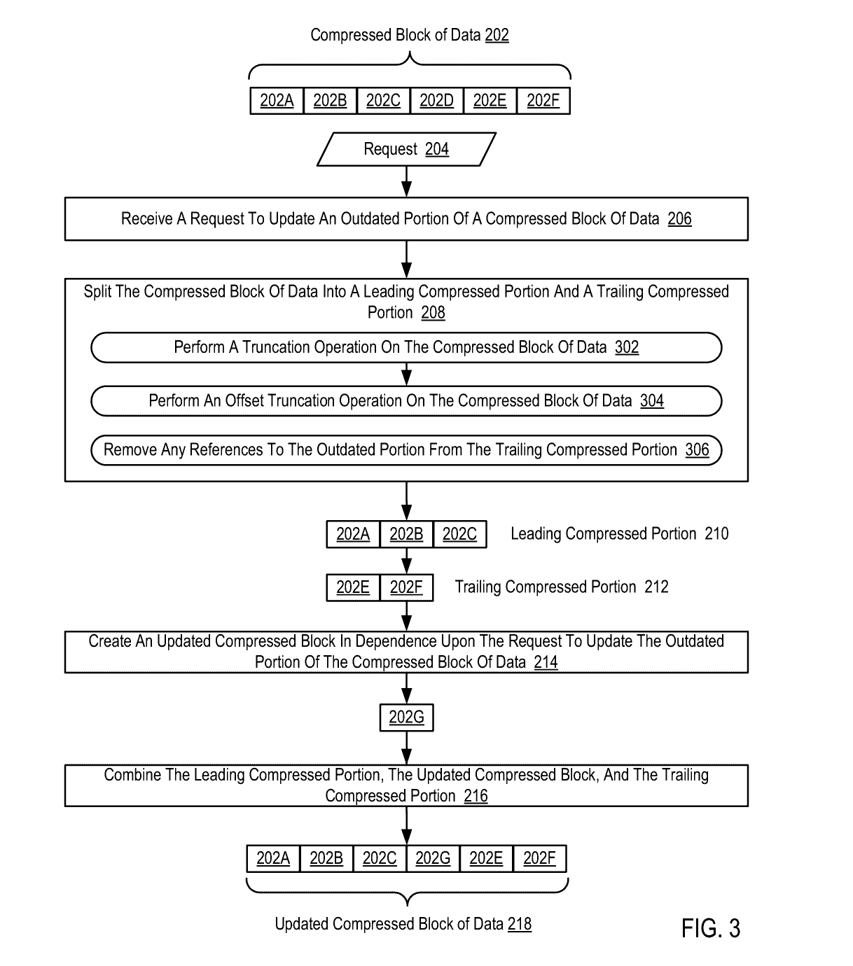

For further explanation, FIG. 3 sets forth a flowchart illustrating an additional example method of modifying a compressed block of data according to embodiments of the present disclosure. The example method depicted in FIG. 3 is similar to the example method depicted in FIG. 2, as the example method depicted in FIG. 3 also includes receiving (206) a request (204) to update an outdated portion of a compressed block of data (202), splitting (208) the compressed block of data (202) into a leading compressed portion (210) and a trailing compressed portion (212), creating (214) an updated compressed block in dependence upon the request (204) to update the outdated portion of the compressed block of data (202), and combining (216) the leading compressed portion (210), the updated compressed block (202G), and the trailing compressed portion (212).

In the example method depicted in FIG. 3, splitting (208) the compressed block of data (202) into a leading compressed portion (210) and a trailing compressed portion (212) can include performing (302) a truncation operation on the compressed block of data (202). The truncation operation may be embodied, for example, as an operation that receives the compressed block of data (202) as input and also receives a value indicating the amount of data to preserve as part of the truncation operation. In such an example, the portion of the compressed block of data (202) that is not included in the amount of data to preserve will be discarded.

Consider an example in which the compressed block of data (202) is 8 bytes in size and the amount of data to preserve as part of the truncation operation is 2 bytes. In such an example, the first 2 bytes of the compressed block of data (202) (i.e., byte 0 and byte 1) will be preserved and the last 6 bytes of the compressed block of data (202) (i.e., byte 2, byte 3, byte 4, byte 5, byte 6, and byte 7) will be discarded. In such an example, the truncation operation will return the first 2 byte s of the compressed block of data (202) as output of the truncation operation. Readers will appreciate that the amount of data to preserve as part of the truncation operation may be expressed in other units of measure such as kilobytes, megabytes, gigabytes, or in other ways such as an address range.

In the example method depicted in FIG. 3, splitting (208) the compressed block of data (202) into a leading compressed portion (210) and a trailing compressed portion (212) can include performing (304) a offset truncation operation on the compressed block of data (202). The offset truncation operation may be embodied, for example, as an operation that receives the compressed block of data (202) as input and also receives a value indicating an offset within the block, where data before the offset is discarded.

Consider an example in which the compressed block of data (202) is 8 bytes in size and the offset value is 3 bytes. In such an example, the first 3 bytes of the compressed block of data (202) (i.e., byte 0, byte 1, and byte 2) will be discarded and the last 5 bytes of the compressed block of data (202) (i.e., byte 3, byte 4, byte 5, byte 6, and byte 7) will be preserved. In such an example, the offset truncation operation will return the last 5 bytes of the compressed block of data (202) as output of the offset truncation operation. Readers will appreciate that the offset value may be expressed in other units of measure such as kilobytes, megabytes, gigabytes, or in other ways such as an address.

Readers will appreciate that through the use of such truncate operations and such offset truncation operations, the compressed block of data (202) may be split (208) into a leading compressed portion (210) and a trailing compressed portion (212). Consider an example in which the compressed block of data is 8 bytes in size, and a user wishes to modify the 3^{rd} byte of the compressed block of data (202). In such an example, a truncation operation may be performed (302) on the compressed block of data (202) where the amount of data to preserve as part of the truncation operation is 2 bytes. In such an example, the first 2 bytes of the compressed block of data (202) (i.e., byte 0 and byte 1) will be preserved, such that the truncation operation will return the first 2 bytes of the compressed block of data (202) as output of the truncation operation. In addition, an offset truncation operation may be performed (304) on the compressed block of data (202) with an offset value of 3 bytes, such that the offset truncation operation will return the last 5 bytes of the compressed block of data (202) (i.e., byte 3, byte 4, byte 5, byte 6, and byte 7) as output of the offset truncation operation. As such, the compressed block of data (202) may be split (208) into a leading compressed portion (210) that includes the first 2 bytes of the compressed block of data (202) that were returned by the truncation operation and a trailing compressed portion (212) that includes the last 5 bytes of the compressed block of data (202) that were returned by the offset truncation operation. Readers will appreciate that in the example described above, neither the leading compressed portion (210) nor the trailing compressed portion (212) includes an outdated portion of the compressed block of data (202) (i.e., the 3^{rd} byte of the compressed block of data (202) that the user wishes to modify). Furthermore, because the truncate operations and the offset truncation operations are performed on compressed data, the data need not be decompressed in order to modify the data.

In the example method depicted in FIG. 3, splitting (208) the compressed block of data (202) into a leading compressed portion (210) and a trailing compressed portion (212) can alternatively include removing (306) any references to the outdated portion from the trailing compressed portion (212). Readers will appreciate that certain compression algorithms compress data such that if a particular data element appears multiple times in a block of data, all instances of the data element that follow the first instance are replaced by references to the first instance of the data element.

Consider an example in which the block of data represents the text string “hello moon, hello sun, goodbye moon, goodbye sun.” In such an example, compressing such a block of data may result in the text string “hello moon,” remaining in its current form, but the next instance of the phrase “hello” being replaced by a reference to the first instance of the same phrase. Likewise, subsequent instances of the following phrases would be replaced by references to the first instance of the same phrases: “moon,” “goodbye” “sun”. For example, the compressed block of data may be as follows:

String1 “hello moon,”

Reference to first 6 characters of String1

String2 “sun, goodbye”

Reference to last 6 characters of String1

Reference to last 7 characters of String2

String3

Reference to first 3 characters of String2

String4 “.”

In such an example, assume that a user issues a request to modify the text contained in String2 of the compressed block such that the text string recites “hello moon, hello stars, goodbye moon, goodbye sun.” In response to such a user request, the compressed block of data would be split (208) such that the leading compressed portion (210) would include String1 and the reference to first 6 characters of String1, while the trailing compressed portion (212) would include the reference to last 6 characters of String1, the reference to the last 7 characters of String2, and String3. In such an example, the outdated portion of the compressed block of data would consist of String2 and some of the references to String2 would no longer be appropriate. In particular, the last reference in the trailing compressed portion (212) (i.e., the reference to first 3 characters of String2) would no longer be appropriate.

In order to account for references to the outdated portion of the compressed block of data (20), in the process of splitting (208) the compressed block of data (202) into the leading compressed portion (210) and the trailing compressed portion (212), some references to the outdated portion may need to be removed (306) from the trailing compressed portion (212). Removing (306) a reference to the outdated portion from the trailing compressed portion (212) may be carried out, for example, by replacing a reference to some data with an actual copy of the data. Continuing with the example described above, removing (306) references to the outdated portion of the compressed data described above may be carried out by replacing the reference to first 3 characters of String2 with a new string that includes “sun”.

Readers will appreciate that an example of a compression algorithm that includes such structures is LZFG, where an encoder generates a compressed file that includes tokens and literals (raw ASCII codes) that are intermixed. LZFG utilizes two types of tokens: a literal and a copy. A literal token indicates that a string of literals follows whereas a copy token points to a string of literals previously seen in the data. Readers will further appreciate that in order to modify a portion of a compressed block of data, a full decompression is not needed, thereby saving memory accesses and all of the processing overhead required to perform such memory accesses. Instead requiring a full decompression, embodiments of the present disclosure may utilize information describing the length of the literals in a compressed block, as well as the length and offset of the back references contained in the compressed block, to turn an encoded binary representation (often entropy coded with Huffman or similar) into a series of literals and back references.

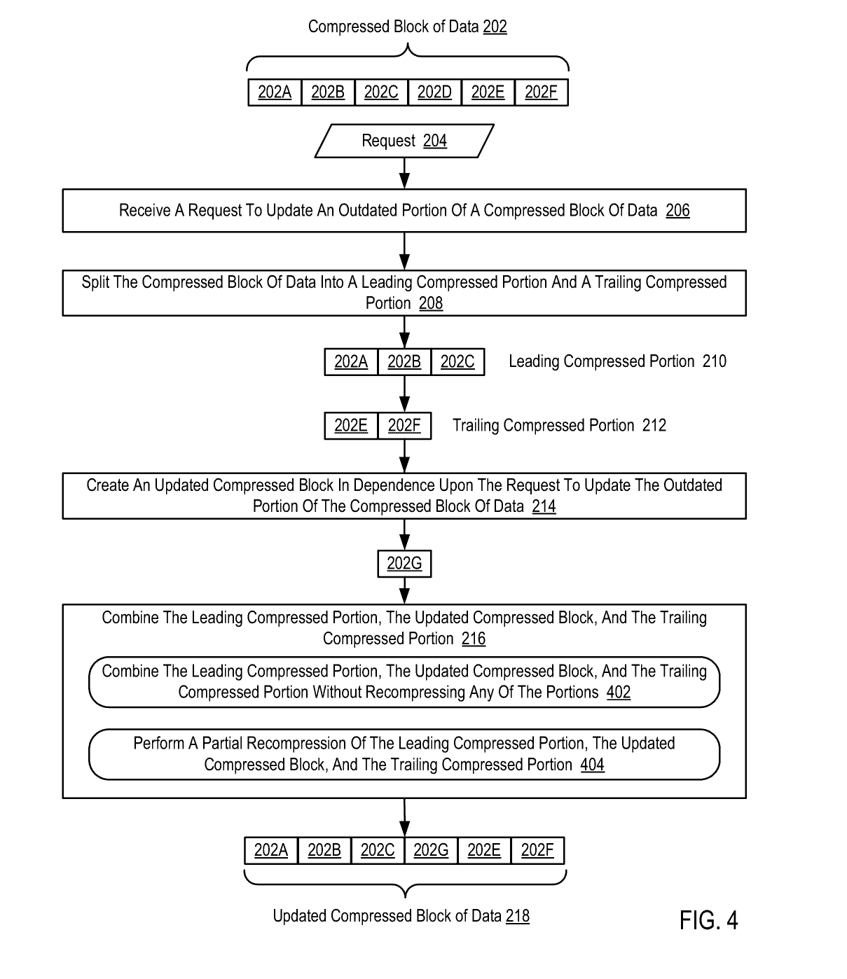

For further explanation, FIG. 4 sets forth a flowchart illustrating an additional example method of modifying a compressed block of data according to embodiments of the present disclosure. The example method depicted in FIG. 4 is similar to the example method depicted in FIG. 2, as the example method depicted in FIG. 4 also includes receiving (206) a request (204) to update an outdated portion of a compressed block of data (202), splitting (208) the compressed block of data (202) into a leading compressed portion (210) and a trailing compressed portion (212), creating (214) an updated compressed block in dependence upon the request (204) to update the outdated portion of the compressed block of data (202), and combining (216) the leading compressed portion (210), the updated compressed block (202G), and the trailing compressed portion (212).

In the example method depicted in FIG. 4, combining (216) the leading compressed portion (210), the updated compressed block (202G), and the trailing compressed portion (212) can include combining (402) the leading compressed portion (210), the updated compressed block (202G), and the trailing compressed portion (212) without recompressing any of the portions (210, 202G, 212). Combining (402) the leading compressed portion (210), the updated compressed block (202G), and the trailing compressed portion (212) without recompressing any of the portions (210, 202G, 212) may be carried out, for example, through the use of one or more operations that combine compressed blocks of data. In such an example, no additional compression algorithms are executed and no additional attempts are made to compress the combined portions (210, 202G, 212).

In the example method depicted in FIG. 4, combining (216) the leading compressed portion (210), the updated compressed block (202G), and the trailing compressed portion (212) can alternatively include performing (404) a partial recompression of the leading compressed portion (210), the updated compressed block (202G), and the trailing compressed portion (212). Performing (404) a partial recompression of the leading compressed portion (210), the updated compressed block (202G), and the trailing compressed portion (212) may be carried out, for example, by searching the updated compressed block (202G) to see determine whether any of the data elements in the updated compressed block (202G) can be replaced with references to identical data elements in the leading compressed portion (210), by searching the trailing compressed portion (212) to see determine whether any of the data elements in the trailing compressed portion (212) can be replaced with references to identical data elements in the updated compressed block (202G), and so on. In such a way, a full recompression of the combined portions (210, 202G, 212) can be avoided by limiting the scope of the compression to focus on those data elements that have changed. Readers will appreciate that, in fact, that performing (404) a partial recompression of the leading compressed portion (210) is entirely optional and in no way required in various embodiments of the present disclosure.

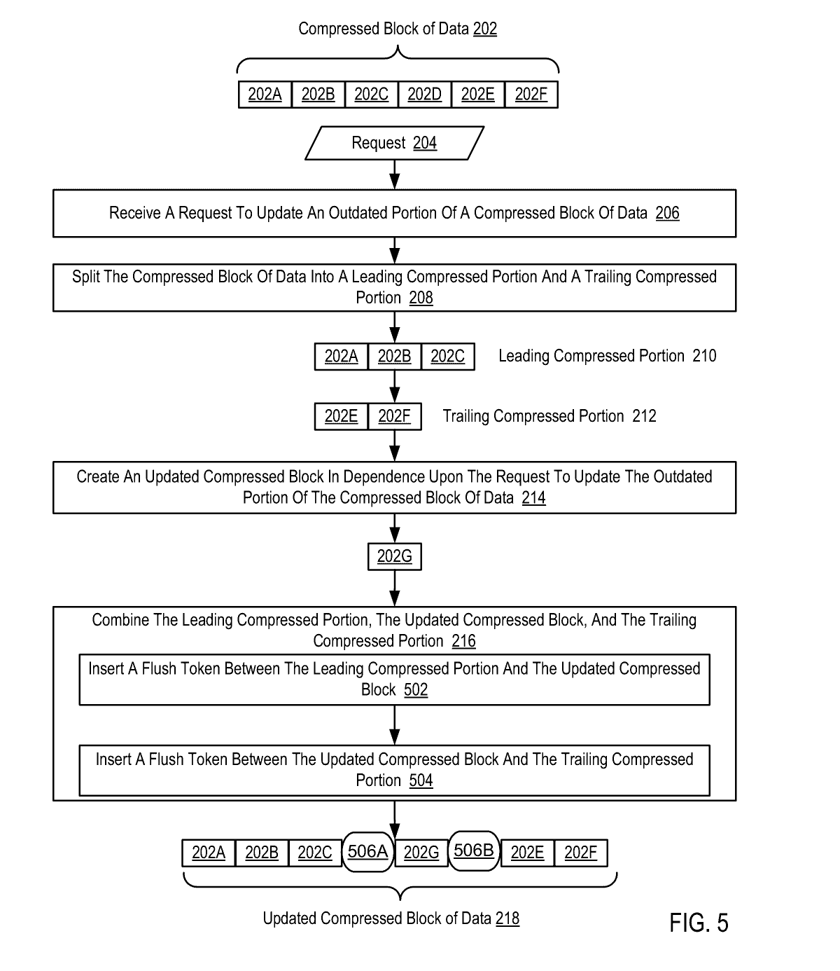

For further explanation, FIG. 5 sets forth a flowchart illustrating an additional example method of modifying a compressed block of data according to embodiments of the present disclosure. The example method depicted in FIG. 5 is similar to the example method depicted in FIG. 2, as the example method depicted in FIG. 5 also includes receiving (206) a request (204) to update an outdated portion of a compressed block of data (202), splitting (208) the compressed block of data (202) into a leading compressed portion (210) and a trailing compressed portion (212), creating (214) an updated compressed block in dependence upon the request (204) to update the outdated portion of the compressed block of data (202), and combining (216) the leading compressed portion (210), the updated compressed block (202G), and the trailing compressed portion (212).

In the example method depicted in FIG. 5, combining (216) the leading compressed portion (210), the updated compressed block (202G), and the trailing compressed portion (212) can include inserting (502) a flush token (506A) between the leading compressed portion (210) and the updated compressed block (202G). The flush token (506A) of FIG. 5 may be embodied, for example, as a data structure that designates the end of one compressed block of data and the beginning of a next compressed block of data. As such, a decompressor will understand that what follows the flush token will include certain encodings associated with a new block of compressed data. In the example method depicted in FIG. 5, combining (216) the leading compressed portion (210), the updated compressed block (202G), and the trailing compressed portion (212) can also include inserting (504) a flush token (506B) between the updated compressed block (202G) and the trailing compressed portion (212).

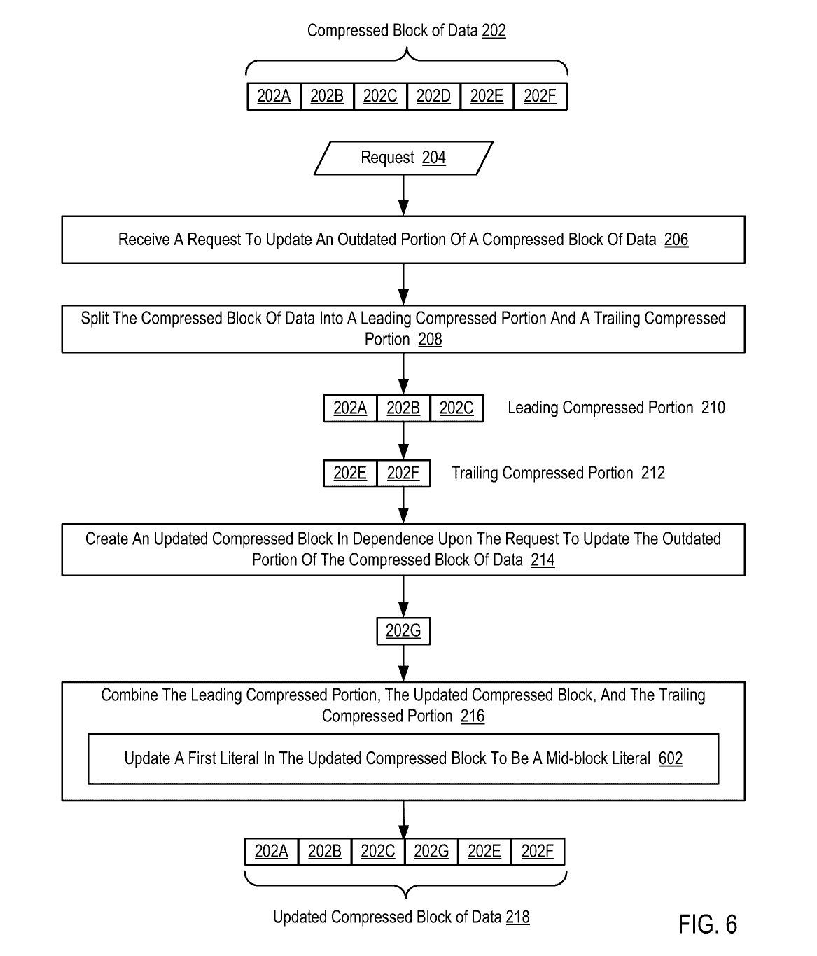

For further explanation, FIG. 6 sets forth a flowchart illustrating an additional example method of modifying a compressed block of data according to embodiments of the present disclosure. The example method depicted in FIG. 6 is similar to the example method depicted in FIG. 2, as the example method depicted in FIG. 6 also includes receiving (206) a request (204) to update an outdated portion of a compressed block of data (202), splitting (208) the compressed block of data (202) into a leading compressed portion (210) and a trailing compressed portion (212), creating (214) an updated compressed block in dependence upon the request (204) to update the outdated portion of the compressed block of data (202), and combining (216) the leading compressed portion (210), the updated compressed block (202G), and the trailing compressed portion (212).

In the example method depicted in FIG. 6, combining (216) the leading compressed portion (210), the updated compressed block (202G), and the trailing compressed portion (212) can include updating (602) a first literal in the updated compressed block (202G) to be a mid-block literal. In the example method depicted in FIG. 6, a literal represents a data element in a compressed block of data that does not match another previously appearing data element in the compressed block of data. Readers will appreciate that some compression algorithms, such as LZS, use an LZ77 type algorithm where the last 2 KB of uncompressed data is used as a sliding-window dictionary. As such, an LZS compressor looks for matches between the data to be compressed and the last 2 KB of uncompressed data in the sliding-window dictionary. If the compressor finds a match, the compressor will encode an offset/length reference to the dictionary. If the compressor does not find a match, however, the next data byte of data is encoded as a “literal” byte. The first literal that appears in a compressed block of data, however, may have a slightly different encoding than the remaining literals (mid-block literals) that appear in the compressed block. As such, combining (216) the leading compressed portion (210), the updated compressed block (202G), and the trailing compressed portion (212) into a single block of compressed data can create the need to update (602) a first literal in the updated compressed block (202G) to be a mid-block literal, as the first literal in the updated compressed block (202G) may not be the first literal contained in the single block of compressed data that is created by combining (216) the leading compressed portion (210), the updated compressed block (202G), and the trailing compressed portion (212). In such an example, updating (602) a first literal in the updated compressed block (202G) to be a mid-block literal may be carried out by changing the encoding of the first literal in the updated compressed block (202G) to take the form of a mid-block literal.

Example embodiments of the present disclosure are described largely in the context of a fully functional computer system for modifying a compressed block of data according to embodiments of the present disclosure. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present disclosure.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of modifying a compressed block of data, the method comprising:
splitting the compressed block of data into a leading compressed portion and a trailing compressed portion, wherein neither the leading compressed portion nor the trailing compressed portion includes an outdated portion of the compressed block of data;
creating an updated compressed block to replace the outdated portion; and
combining the leading compressed portion, the updated compressed block, and the trailing compressed portion.

2. The method of claim 1 wherein splitting the compressed block of data into the leading compressed portion and the trailing compressed portion further comprises:
performing a truncation operation on the compressed block of data; and
performing an offset truncation operation on the compressed block of data.

3. The method of claim 1 wherein splitting the compressed block of data into the leading compressed portion and the trailing compressed portion further comprises removing references to the outdated portion from the trailing compressed portion.

4. The method of claim 1 wherein combining the leading compressed portion, the updated compressed block, and the trailing compressed portion further comprises combining the leading compressed portion, the updated compressed block, and the trailing compressed portion without recompressing any of the portions.

5. The method of claim 1 wherein combining the leading compressed portion, the updated compressed block, and the trailing compressed portion further comprises performing a partial recompression of the leading compressed portion, the updated compressed block, and the trailing compressed portion.

6. The method of claim 1 wherein combining the leading compressed portion, the updated compressed block, and the trailing compressed portion further comprises:
inserting a flush token between the leading compressed portion and the updated compressed block; and
inserting a flush token between the updated compressed block and the trailing compressed portion.

7. The method of claim 1 wherein combining the leading compressed portion, the updated compressed block, and the trailing compressed portion further comprises updating a first literal in the updated compressed block to be a mid-block literal.

8. An apparatus for modifying a compressed block of data, the apparatus including a computer processor and a computer memory, the computer memory including computer program instructions that, when executed by the computer processor, cause the apparatus to carry out the steps of:
splitting the compressed block of data into a leading compressed portion and a trailing compressed portion, wherein neither the leading compressed portion nor the trailing compressed portion includes an outdated portion of the compressed block of data;
creating an updated compressed block to replace the outdated portion; and
combining the leading compressed portion, the updated compressed block, and the trailing compressed portion.

9. The apparatus of claim 8 wherein splitting the compressed block of data into the leading compressed portion and the trailing compressed portion further comprises:
performing a truncation operation on the compressed block of data; and
performing an offset truncation operation on the compressed block of data.

10. The apparatus of claim 8 wherein splitting the compressed block of data into the leading compressed portion and the trailing compressed portion further comprises removing references to the outdated portion from the trailing compressed portion.

11. The apparatus of claim 8 wherein combining the leading compressed portion, the updated compressed block, and the trailing compressed portion further comprises combining the leading compressed portion, the updated compressed block, and the trailing compressed portion without recompressing any of the portions.

12. The apparatus of claim 8 wherein combining the leading compressed portion, the updated compressed block, and the trailing compressed portion further comprises performing a partial recompression of the leading compressed portion, the updated compressed block, and the trailing compressed portion.

13. The apparatus of claim 8 wherein combining the leading compressed portion, the updated compressed block, and the trailing compressed portion further comprises:
inserting a flush token between the leading compressed portion and the updated compressed block; and
inserting a flush token between the updated compressed block and the trailing compressed portion.

14. The apparatus of claim 8 wherein combining the leading compressed portion, the updated compressed block, and the trailing compressed portion further comprises updating a first literal in the updated compressed block to be a mid-block literal.

15. A computer program product for modifying a compressed block of data, the computer program product disposed upon a computer readable medium, the computer program product comprising computer program instructions that, when executed, cause a computer to carry out the steps of:
splitting the compressed block of data into a leading compressed portion and a trailing compressed portion, wherein neither the leading compressed portion nor the trailing compressed portion includes an outdated portion of the compressed block of data;
creating an updated compressed block to replace the outdated portion; and
combining the leading compressed portion, the updated compressed block, and the trailing compressed portion.

16. The computer program product of claim 15 wherein splitting the compressed block of data into the leading compressed portion and the trailing compressed portion further comprises:
performing a truncation operation on the compressed block of data; and
performing an offset truncation operation on the compressed block of data.

17. The computer program product of claim 15 wherein splitting the compressed block of data into the leading compressed portion and the trailing compressed portion further comprises removing references to the outdated portion from the trailing compressed portion.

18. The computer program product of claim 15 wherein combining the leading compressed portion, the updated compressed block, and the trailing compressed portion further comprises combining the leading compressed portion, the updated compressed block, and the trailing compressed portion without recompressing any of the portions.

19. The computer program product of claim 15 wherein combining the leading compressed portion, the updated compressed block, and the trailing compressed portion further comprises performing a partial recompression of the leading compressed portion, the updated compressed block, and the trailing compressed portion.

20. The computer program product of claim 15 wherein combining the leading compressed portion, the updated compressed block, and the trailing compressed portion further comprises:
inserting a flush token between the leading compressed portion and the updated compressed block; and
inserting a flush token between the updated compressed block and the trailing compressed portion.
